(19) United States
(12) Patent Application Publication
(10) Pub. No.: US 2026/0221702 A1
(43) Pub. Date: Jul. 30, 2026

(54) SPRING CLIP AND ASSOCIATED CONNECTOR

(71) Applicant: FCI USA LLC, Etters, PA (US)

(72) Inventors: Thomas Teschke, Munich (DE); Charles Copper, Hummelstown, PA (US); Thierry Goossens, Herdersem (BE)

(73) Assignee: FCI USA LLC, Etters, PA (US)

(21) Appl. No.: 19/573,372

(22) Filed: Mar. 20, 2026

Related U.S. Application Data
(60) Provisional application No. 63/775,660, filed on Mar. 21, 2025.

(51) Int. Cl. H01R 25/14; H01R 43/20

(52) U.S. Cl. CPC H01R 25/142; H01R 43/20

(57) ABSTRACT

A connector includes at least one electrical contact for receiving a conductive component; and a spring clip configured to apply a force in an inward direction on the at least one electrical contact to mechanically retain the conductive component. The spring clip has an open frame configuration.

### CROSS-REFERENCE TO RELATED APPLICATIONS

The present application claims priority to and the benefit under 35 U.S.C. 119 of U.S. Provisional Application 63/775,660, filed Mar. 21, 2025, titled “SPRING CLIP AND ASSOCIATED CONNECTOR,” the contents of which is hereby incorporated herein by reference in its entirety.

### TECHNICAL FIELD

The present disclosure generally to electrical connectors, and in particular to electrical connectors for engaging with a busbar.

### BACKGROUND

The subject matter described and/or illustrated herein relates generally to electrical connectors that have opposing electrical contacts configured to engage opposite sides of a conductive component.

In some electrical systems, power is delivered to a circuit board or other electrical component through a busbar and a busbar connector. A busbar typically comprises a planar strip of conductive material (e.g., copper) having opposite sides which are engaged by the busbar connector. Existing busbar connectors include a housing that holds two mating contacts that oppose each other with a space therebetween. When a subassembly with a busbar connector is inserted into a rack, each of the mating contacts of the busbar connector electrically engages a corresponding side of the busbar at the back of the rack. In some connectors, the mating contacts are configured to adjust if the busbar is inserted into the space in a misaligned manner. For instance, when the busbar is misaligned, the busbar may press against a first mating contact with more force than a second mating contact that opposes the first mating contact. In such cases, the connector may include a mechanism for adjusting the mating contacts within the housing so that both of the mating contacts sufficiently engage the busbar.

FIG. 1 is an exploded view of an electrical system 100. As shown, the electrical system 100 includes an electrical element 102 (e.g., a circuit board), an electrical connector 104 that is configured to be mounted to the electrical element 102, and a conductive component 106 that is configured to communicatively engage the electrical connector 104. The conductive component 106 includes a leading edge 107 that is configured to be received by the electrical connector 104. The conductive component 106 may be elongated along an elevation axis 192 and may be wider along the longitudinal axis 191 (along a mating direction) than along a lateral axis 193. The conductive component 106 may be a busbar. The electrical connector 104 may include electrical contacts 122 (shown in FIGS. 2) and 124 that are configured to transmit electrical power therethrough. However, in other cases, the conductive component 106 may be, for example, a card connector and the electrical connector 104 may have electrical contacts configured to transmit data signals therethrough. Alternatively, the conductive component 106 could be a printed circuit board with multiple conductive layers including two outer conductive layers that face in opposite directions. As shown, the electrical system 100 and the electrical connector 104 are oriented with respect to mutually perpendicular axes 191-193 that include a longitudinal axis 191, an elevation (or vertical) axis 192, and a lateral (or horizontal) axis 193. Although in some cases the elevation axis 192 may extend along a gravitational force direction, the elevation axis 192 is not required to have any particular orientation with respect to gravity.

The conductive component 106 also has a pair of sides 108, 110 and a thickness T1 extending therebetween. The sides 108, 110 face in opposite directions along the lateral axis 193. The conductive component 106 is configured to be electrically engaged to the electrical connector 104 on each side 108, 110. In some cases, the conductive component 106 comprises a busbar having multiple layers including power layers 112, 114 and a dielectric layer 116 that is located between the power layers 112, 114. The power layer 112 includes the side 108, and the power layer 114 includes the side 110. In one example, the power layers 112, 114 are electrically independent and capable of having different voltages. In another example, the conductive component 106 may have separate electrical contacts (e.g., contact pads) along the sides 108, 110 that are capable of transmitting data signals. In an example, the electrical contacts 122, 124 are also electrically independent and capable of operating at different voltages. In other cases, conductive component 106 may have a single conductor (e.g., a single piece of conductive material, such as copper, for example). The present application is not limited as to the composition of conductive component 106, as the techniques and structures described herein may be used regardless of the composition of conductive component 106 or the number of independent electrical terminals of conductive component 106.

The electrical connector 104 includes a connector housing 120 having an interior cavity 125 and a socket opening 140 that provides access to the interior cavity 125. The pair of electrical contacts 122, 124 is disposed within the interior cavity 125. The electrical contacts 122, 124 may include respective mounting portions 126, 128. In the illustrated example, the mounting portions 126, 128 are configured to be directly coupled to the electrical element 102 using fasteners 130, 132. The mounting portions 126, 128 establish an electrical connection with the electrical element 102 through mounting contacts 134, 136. In other cases, the electrical contacts 122, 124 may be coupled to the electrical element 102 in other manners. For example, the mounting portions 126, 128 may include compliant pins or tails that are inserted into plated thru-holes of the electrical element 102 when the electrical element 102 is a circuit board. The mounting portions 126, 128 may also be indirectly coupled to, for example, another electrical connector or different conductive pathways.

In some cases, the conductive component 106 has an elongated and substantially rectangular-shaped body that is configured to be gripped on both sides 108, 110 by the electrical connector 104. For example, the sides 108 and 110 have surfaces that coincide with respective planes that extend along the longitudinal and elevation axes 191, 192 and are parallel to each other. In the illustrated example, the socket opening 140 has an elongated dimension D1 that is measured along the elevation axis 192 and a short dimension D2 that is measured along the lateral axis 193. The dimension D2 is sized to accommodate the thickness T1 of the conductive component 106. Accordingly, the socket opening 140 is configured to receive the conductive component 106 when the leading edge 107 of the conductive component 106 is advanced into the socket opening 140 along a mating direction M1. The mating direction M1 extends substantially parallel to the longitudinal axis 191.

FIG. 2 is an exploded perspective view of the electrical connector 104. In some cases, the electrical connector 104 includes the connector housing 120 (FIG. 2) and the contact assembly 145. The contact assembly 145 is configured to be disposed within the interior cavity 125 (FIG. 2) of the connector housing 120. The contact assembly 145 includes the electrical contacts 122, 124, an insulative partition 144 between the electrical contacts 122, 124, and a spring clip 142.

As shown in FIG. 2, the electrical contact 122 extends longitudinally between front and rear ends 302, 304 and has inner and outer surfaces 306, 308 that face in opposite directions along the lateral axis 193 (FIG. 1). The electrical contact 124 also extends longitudinally between front and rear ends 312, 314 and has inner and outer surfaces 316, 318 that face in opposite directions. When the electrical connector 104 is assembled, the inner surfaces 306, 316 face each other and may have the insulative partition 144 located therebetween. The spring clip 142 may be configured to surround the electrical contacts 122, 124 such that the outer surfaces 308, 318 face the spring clip 142. The spring clip 142 is configured to mechanically engage the outer surfaces 308, 318.

The spring clip 142 is designed to press inward on the electrical contacts 122 and 124 so that the conductive component 106 can be securely held between the electrical contacts 122 and 124. That is, the spring clip presses on electrical contacts 122 and 124 in an inward direction along axis 193, such that the electrical contacts 122 and 124 in turn press inwardly on the sides of the conductive component 106 to maintain a strong mechanical and electrical connection between the electrical contacts 122, 124 and the conductive component 106. However, the inventors have appreciated with such a design that only limited misalignment between the conductive component 106 and the electrical connector 104 can be tolerated. In particular the spring clip 142 may prevent the electrical contacts 122 and 124 from flexing to a significant degree to accommodate misalignment of the conductive component 106 and the electrical connector 104 along axis 193.

### SUMMARY

In some aspects, the techniques described herein relate to a spring clip for a connector, the spring clip being configured to press inwardly on one or more contacts to secure a conductive component between the one or more contacts, the spring clip including: at least one spring portion; and at least one retaining portion, wherein the spring clip has an open frame configuration.

In some aspects, the techniques described herein relate to a spring clip, wherein the at least one spring portion includes a plurality of spring portions.

In some aspects, the techniques described herein relate to a spring clip, wherein the at least one retaining portion includes a plurality of retaining portions.

In some aspects, the techniques described herein relate to a spring clip, wherein the plurality of spring portions are mechanically connected to one another by the plurality of retaining portions.

In some aspects, the techniques described herein relate to a spring clip, wherein the plurality of spring portions are U-shaped.

In some aspects, the techniques described herein relate to a spring clip, wherein the plurality of retaining portions are straight.

In some aspects, the techniques described herein relate to a spring clip for a connector, the spring clip being configured to press inwardly on one or more contacts to secure a conductive component between the one or more contacts, the spring clip having an open frame configuration.

In some aspects, the techniques described herein relate to a connector, including: at least one electrical contact for receiving a conductive component; and a spring clip configured to apply a force in an inward direction on the at least one electrical contact to mechanically retain the conductive component, the spring clip having an open frame configuration.

In some aspects, the techniques described herein relate to a connector, wherein the connector is a busbar connector.

In some aspects, the techniques described herein relate to a connector, wherein the spring clip includes a plurality of spring portions.

In some aspects, the techniques described herein relate to a connector, wherein the spring clip includes a plurality of retaining portions.

In some aspects, the techniques described herein relate to a connector, wherein the plurality of retaining portions are straight.

In some aspects, the techniques described herein relate to a connector, wherein the plurality of spring portions are mechanically connected to one another by the plurality of retaining portions.

In some aspects, the techniques described herein relate to a connector, wherein the plurality of spring portions are U-shaped.

In some aspects, the techniques described herein relate to a connector, further including an adapter plate connected to the at least one electrical contact, the adapter plate being configured to mount the connector to a base.

In some aspects, the techniques described herein relate to a connector, wherein the adapter plate and the at least one electrical contact have complementary registration features.

In some aspects, the techniques described herein relate to a connector, including: at least one electrical contact for receiving a conductive component; and a spring clip configured to apply a force in an inward direction on the at least one electrical contact to mechanically retain the conductive component, wherein the spring clip has at least one opening away from a portion of the spring clip configured to press on the at least one electrical contact, the at least one opening configured to allow a portion of the at least one electrical contact to extend through the at least one opening.

In some aspects, the techniques described herein relate to a connector, wherein the spring clip is configured to apply the force along a lateral axis and the at least one opening is configured to allow portions of the at least one electrical contact to extend through the at least one opening on both sides of the spring clip with respect to the lateral axis.

In some aspects, the techniques described herein relate to a connector, wherein the at least one opening is configured to allow at least one portion of the at least one electrical contact to extend through the at least one opening past a distal end of the spring clip on an opposite side of the connector from a mating side of the connector.

In some aspects, the techniques described herein relate to a connector, wherein the at least one opening is exactly one opening.

In some aspects, the techniques described herein relate to a connector configured to mechanically electrically engage with a conductive component, the conductive component being wider along a longitudinal axis than a lateral axis, the connector including; at least one electrical contact configured to mechanically and electrically engage with the conductive component on opposite sides of the conductive component with respect to the lateral axis; and a spring clip configured to apply a force in an inward direction on the at least one electrical contact to mechanically retain the conductive component, the spring clip including: retaining portions extending along the longitudinal axis, the retaining portions contacting the at least one electrical contact; and spring portions on opposite sides of the conductive component with respect to the longitudinal axis, the spring portions exerting an inward force on the retaining portions.

In some aspects, the techniques described herein relate to a connector, wherein the spring portions are mechanically connected to one another by the retaining portions.

In some aspects, the techniques described herein relate to a connector, wherein the spring portions are U-shaped.

In some aspects, the techniques described herein relate to a connector, wherein the retaining portions are straight.

In some aspects, the techniques described herein relate to a connector, wherein the at least one electrical contact extends beyond a frame of the spring clip along the lateral axis.

In some aspects, the techniques described herein relate to a connector, wherein the connector is configured to engage with a conductive component that is a busbar.

In some aspects, the techniques described herein relate to a connector, further including an adapter plate, wherein the at least one electrical contact is attached to the adapter plate.

In some aspects, the techniques described herein relate to a connector, wherein the adapter plate and the at least one electrical contact have complementary registration features.

In some aspects, the techniques described herein relate to a connector, wherein the adapter plate has registration features configured to allow attachment of the at least one electrical contact to the adapter plate in a first orientation or a second orientation.

In some aspects, the techniques described herein relate to a connector, wherein the first orientation is perpendicular to the second orientation.

In some aspects, the techniques described herein relate to a spring clip configured to apply a force in an inward direction on at least one electrical contact to mechanically retain a conductive component, the spring clip including: retaining portions extending along a longitudinal axis, the retaining portions contacting the at least one electrical contact; and spring portions on opposite sides of the conductive component with respect to the longitudinal axis, the spring portions exerting an inward force on the retaining portions.

In some aspects, the techniques described herein relate to a spring clip, wherein the spring portions are mechanically connected to one another by the retaining portions.

In some aspects, the techniques described herein relate to a spring clip, wherein the spring portions are U-shaped.

In some aspects, the techniques described herein relate to a spring clip, wherein the retaining portions are straight.

In some aspects, the techniques described herein relate to a spring clip, wherein the at least one electrical contact extends beyond a frame of the spring clip along a lateral axis perpendicular to the longitudinal axis.

In some aspects, the techniques described herein relate to a spring clip, wherein the conductive component a busbar.

In some aspects, the techniques described herein relate to a method of assembling a connector, including: attaching at least one electrical contact to a conductive base; positioning a spring clip over the at least one electrical contact by inserting the at least one electrical contact into an opening at a distal end of the spring clip; and installing a housing over the at least one electrical contact and the spring clip.

In some aspects, the techniques described herein relate to a method, wherein the conductive base includes an adapter plate configured to attach the connector to a conductive element.

In some aspects, the techniques described herein relate to a method, wherein the adapter plate includes copper or a copper alloy.

In some aspects, the techniques described herein relate to a method, further including aligning registration features of the at least one electrical contact and the conductive base prior to the attaching.

In some aspects, the techniques described herein relate to a method, wherein the attaching of the at least one electrical contact to the conductive base includes welding the at least one electrical contact to the conductive base.

### BRIEF DESCRIPTION OF THE DRAWINGS

In the drawings, each identical or nearly identical component that is illustrated in various figures may be represented by a like numeral. For purposes of clarity, not every component may be labeled in every drawing. In the drawings:

FIG. 1 is an exploded view of an electrical system having an electrical connector.

FIG. 2 is an exploded perspective view of the electrical connector of FIG. 1.

FIG. 3A shows a perspective view of an example of a spring clip with an open frame configuration, according to some embodiments.

FIG. 3B shows a perspective view of contacts configured to engage with the spring clip of FIG. 3A.

FIG. 3C shows a perspective view illustrating the spring clip positioned on the contacts.

FIG. 3D shows a side view illustrating flexing of the contacts to accommodate misalignment with a mating conductive component.

FIG. 4 shows a perspective view of an electrical connector including a spring clip, contacts, and a housing.

FIG. 5A shows a side view of the connector of FIG. 4 with the mating conductive component misaligned to the left.

FIG. 5B shows a side view of the connector of FIG. 4 with the mating conductive component misaligned to the right.

FIG. 6 is a perspective view of another embodiment of an electrical connector in which the contacts and housing are disposed on an adapter plate that can be mounted to the conductive element.

FIGS. 7A and 7B show perspective views of the connector of FIG. 6 unmounted and mounted, respectively, to the adapter plate in a first orientation.

FIGS. 7C and 7D show perspective views of the connector of FIG. 6 unmounted and mounted, respectively, to the adapter plate in a second orientation perpendicular to the first orientation.

FIG. 7E is a detail view showing the contacts may have complementary registration features to those of the adapter plate.

FIGS. 8A-8D illustrate successive steps in a method of forming the connector of FIG. 6, according to some embodiments.

FIG. 9 is a perspective view of a spring clip according to some embodiments.

FIG. 10 is a side, sectional view of the connector of FIG. 6 illustrating how the connector tolerates misalignment of the conductive component.

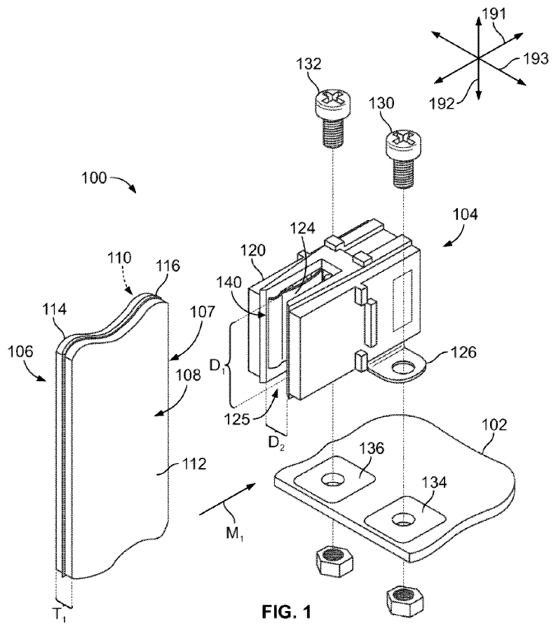

### DETAILED DESCRIPTION

The inventors have recognized and appreciated designs for busbar connectors that facilitate reliable operation of electronic systems. Busbar connectors incorporating these designs can tolerate a larger amount of lateral misalignment with respect to a busbar than conventional designs. Electronic devices using such connectors are less likely to be damaged in use or lead to improper or difficult assembly of the system. Such connectors may be used, for example, to connect electronic devices that are installed in an equipment rack and blind mate to a bus bar. The ability of the connector to tolerate a larger amount of misalignment between the connector and the bus bar increases the chances that the electronic device may be inserted into the rack easily and properly connected to a power source through the busbar. Conversely, the risk of damage from misalignment is reduced. The chances of the user needing to exert excessive force when inserting the electronic device to achieve proper mating or that the connector is not properly mated and interfering with operation of the system are also reduced. This simple and reliable operation may be achieved even in a blind mate scenario.

Described herein is an improved spring clip that can allow the electrical contacts to flex to a more significant degree, allowing for tolerance of a greater misalignment between the conductive component and the electrical connector. In particular, such a spring clip may have an open frame configuration that allows more significant flexing of the electrical contacts. A spring clip with an open frame configuration may have an opening configured to allows a portion of the contacts to extend through the opening past a boundary of the spring clip in a lateral direction and/or a distal direction of the connector, the distal direction being a direction opposite of a mating direction toward the conductive component 106.

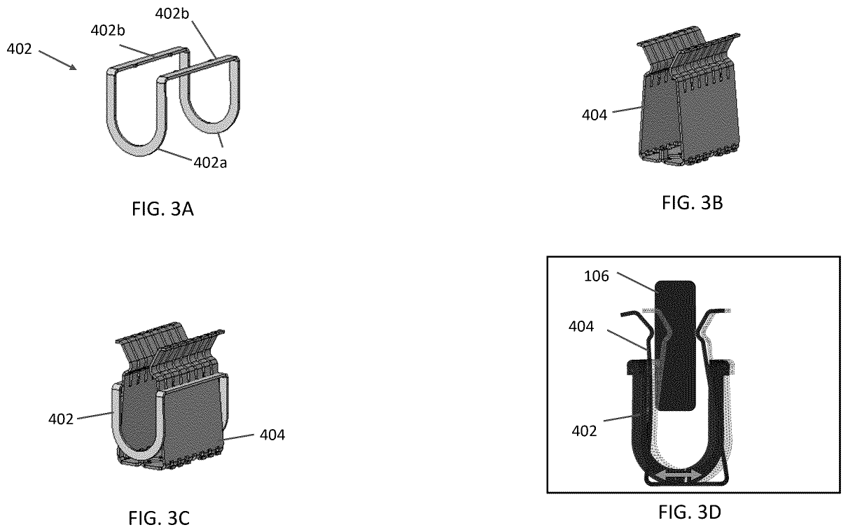

FIG. 3A shows an example of a spring clip 402 with an open frame configuration, according to some embodiments. In this example, the spring clip 402 includes spring portions 402a (illustrated here as U-shaped portions) joined by retaining portions 402b (illustrated here as straight portions). The spring clip 402 may perform the same function as the spring clip 142 discussed above. That is, the spring clip 402 may exert an inward force on the electrical contacts along axis 193, which may resist the force of an object such as conductive component 106 pressing on the electrical contacts in a manner that would push apart the retaining portions 402b. Although spring portions 402a are shown as being U-shaped, the present application is not limited in this respect, as spring portions 402a may have other suitable shapes, such as other curved or non-curved shapes. Further, although retaining portions 402b are shown as being straight, the present application is also not limited in this respect, as retaining portions 402b may have other shapes, such as curved shapes, or other shapes that are not straight.

The spring clip 402 may be formed of any suitable material for applying a restoring force. For example, a spring clip such as spring clip 402 may be formed of a metal, such as steel, for example. However, the present application is not limited as to steel as the material of the spring clip, as other materials may be used having suitable strength and stiffness.

FIG. 3B shows a connector may include one or more contact(s) 404 for making electrical and mechanical contact with a conductive component 106. Contact(s) 404 may be a single contact, for example in the case where only a single electrical connection is to be made to conductive component 106. In other examples contact(s) 404 may comprise separate contacts on opposite sides of the connector. In some cases the contacts may be insulated from one another (e.g., for making more than one electrical connection to conductive component 106). Contact(s) 404 may be formed of any suitable electrically conductive material, such as copper, for example. Contact(s) 404 are configured to flex apart, such that conductive component 106 can be inserted into contact(s) 404 (e.g., from the top direction of FIG. 3B toward the downward direction).

FIG. 3C shows the spring clip 402 positioned on contact(s) 404 in a matter such that spring clip 402 can exert an inward restoring force, with the retaining portions 402b pressing inward on the contact(s) 404 in response to a spring force produced by spring portions 402a. The open frame configuration of the spring clip 402 allows the contact(s) 404 to extend into areas below and above the locations of the retaining portions 402b in the outward direction (farther away from the conductive component 106 than the retaining portions 402b). Allowing contact(s) 404 to flex in this manner allows for greater tolerance of misalignment between the contact(s) 404 and the conductive component 106 when the conductive component 106 is pressed into the contact(s) 404.

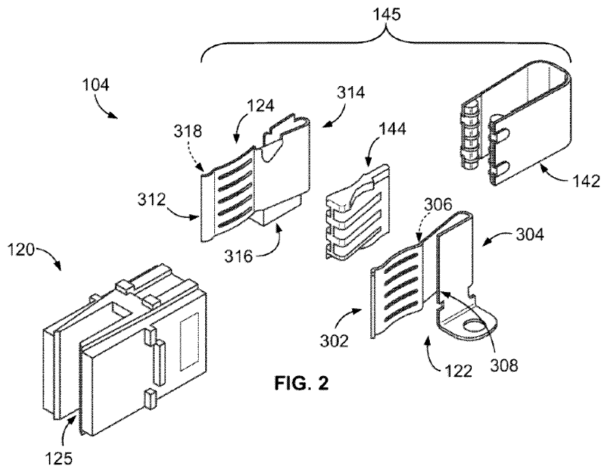

FIG. 3D illustrates how the top and/or bottom portions of contact(s) 404 can flex to a significant degree to accommodate misalignment with respect to the conductive component 106. Due to at least one opening at the side and/or bottom (distal portion) of the spring clip, the bottom portions of contact(s) 404 are able to extend into locations outside of the frame structure of the spring clip 402, which would not have been possible with a closed spring clip configuration, such as with spring clip 142 (FIG. 2).

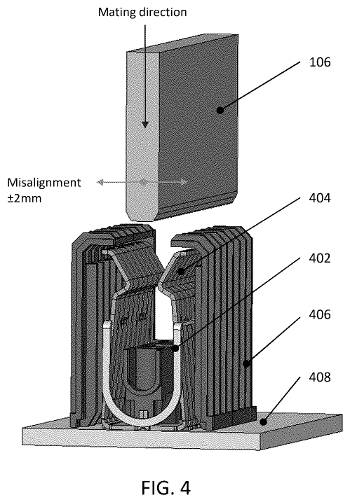

FIG. 4 shows a perspective view of an electrical connector (e.g., a busbar connector) including spring clip 402, contact(s) 404, and a housing 406. The electrical connector may electrically connect conductive component 106 to mating conductive element 408, which may be another busbar, or a printed circuit board (PCB), though not limited thereto. The spring portions of the spring clip 402 are positioned to the sides of contact(s) 404 (in front of and behind in the orientation of FIG. 4). The open frame configuration of spring clip 402 allows the bottom of the contact(s) 404 to protrude through the sides of the spring clip, providing added mechanical flexibility. As shown, the connector may tolerate misalignment of the conductive component 106 by +/−2 mm along the lateral (horizontal) axis. However, this is an example, and the connectors described herein are not limited to such a tolerance.

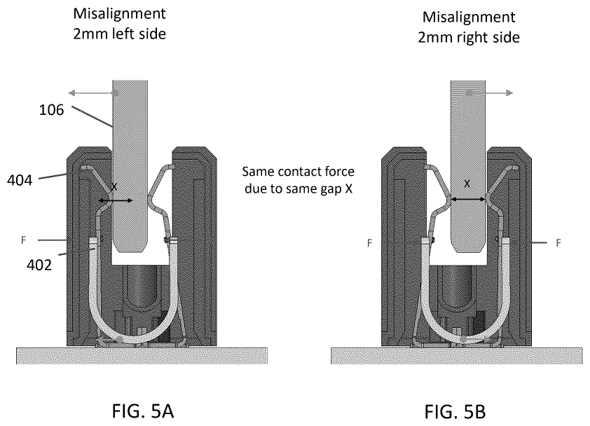

FIGS. 5A and 5B show side views illustrating how the connector of FIG. 4 tolerates misalignment of the conductive component 106 to the left (FIG. 5A) and to the right (FIG. 5B) along the lateral axis.

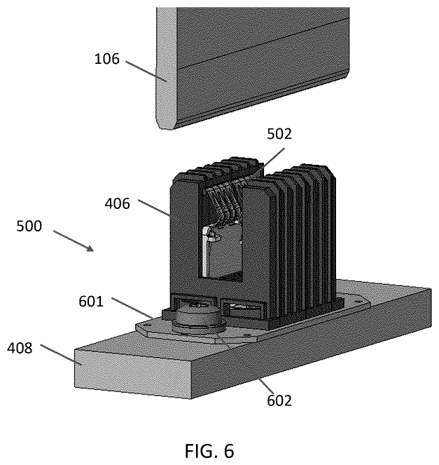

FIG. 6 is a perspective view of another embodiment of an electrical connector 500 in which the contacts and housing are disposed on an adapter plate 601 that can be mounted to the conductive element 408. Adapter plate 601 may be mounted on the conductive element 408 by one or more fasteners 602 (e.g., screws). Adapter plate 601 may be formed of a conductive material, such as a highly conductive metal (e.g., copper or copper alloy).

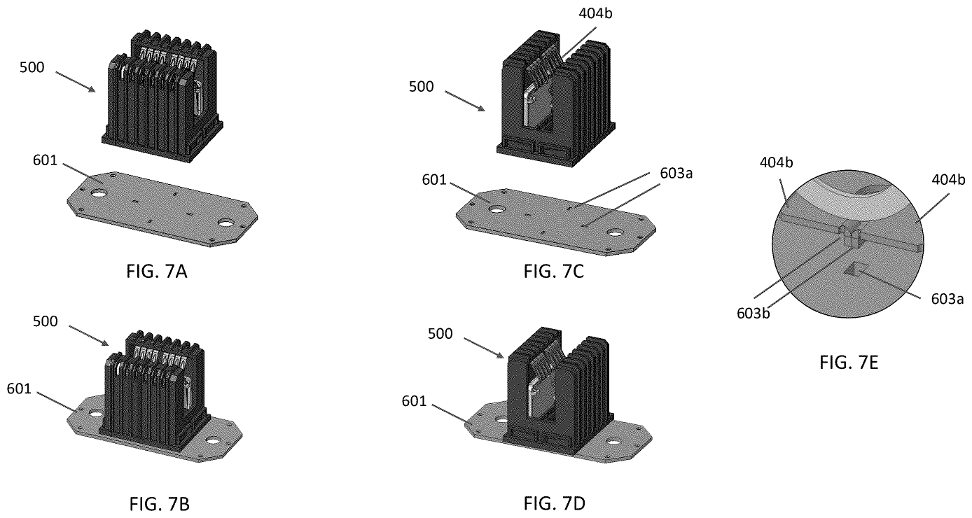

The adapter plate 601 may allow mounting of the connector 500 in different orientations. FIGS. 7A and 7B show perspective views of the connector 500 unmounted and mounted to the adapter plate 601 in a first orientation, respectively. Mounting the connector 500 to the adapter plate 601 in the first orientation allows engagement with a conductive component 106 that has a long dimension parallel to that of the long dimension of the adapter plate 601. FIGS. 7C and 7D show perspective views of the connector 500 unmounted and mounted, respectively, to the adapter plate 601 in a second orientation perpendicular to the first orientation. Mounting the connector 500 to the adapter plate 601 in the second orientation allows engagement with a conductive component 106 that has a long dimension perpendicular to that of the long dimension of the adapter plate 601.

The adapter plate 601 may have registration features 603a complementary to those of contacts 404b to allow positioning of the connector 500 in the first orientation or the second orientation. FIG. 7C shows the registration features 603a on the adapter plate 601 may be holes or recesses in the adapter plate located at positions supporting orienting the connector 500 in the first orientation or the second orientation. FIG. 7E is a detail view showing the contacts 404b may have complementary registration features 603b to the registration features 603a of the adapter plate. In this example, the registration features 603b are protrusions extending from the bottom of the contacts 404b. Positioning the contacts 404b such that the registration features 603b are inserted into the registration features 603a allows positioning the contacts 404b at a suitable location on the adapter plate 601.

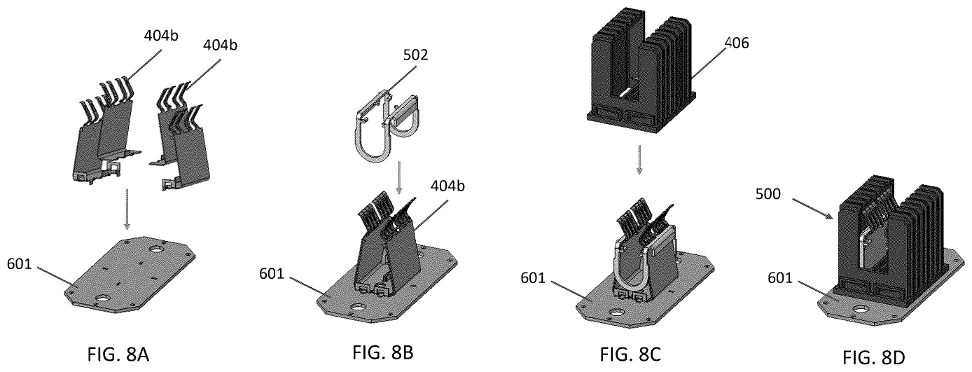

FIGS. 8A-8D show a method of forming connector 500 with an adapter plate 601, according to some embodiments. FIG. 8A shows that the contacts 404b may include more than one contact 404b on each side of the connector that may be nested within each other, with interdigitated contact regions. In other embodiments, each side of the connector may have a single contact 404b. Once the registration features of the contacts 404b and the adapter plate 601 are aligned as discussed above, the contacts 404b may be pressed onto the adapter plate. The contacts 404b may then be attached to the adapter plate 601 using a suitable process, such as welding, for example. As shown in FIG. 8B, the spring clip 502 may then be installed on contacts 404b by placing spring clip 502 on contacts 404b from above. As shown in FIG. 8C, the housing 406 may then be installed over contacts 404b and spring clip 502. The housing 406 may attach to the contacts 404b though protrusions such as tabs on the contacts 404b. FIG. 8D shows the formed connector 500. The formed connector 500 may be attached to conductive element 408 with one or more fasteners 602, as shown in FIG. 6 and discussed above.

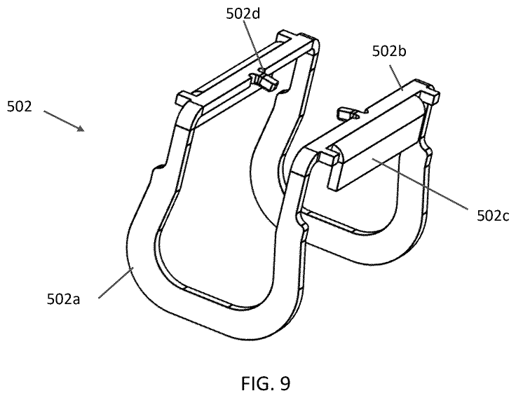

FIG. 9 shows a perspective view of a spring clip 502. Spring clip 502 is similar to spring clip 402 in having an open frame configuration and retaining portions 502b between spring portions 502a. The width of spring portions 502a determines the force produced by spring clip 502 and thus the contact force of contacts 404b contacting the conductive component 106. Spring clip 502 also has stiffener portions 502c extending down from the retaining portions 502b. Stiffener portion 502c helps to resist bending of retaining portions 502b. Spring clip 502 also has inward facing protrusions 502d which allow for the fixation and positioning of the spring clip 502 relative to the contacts 404b. The inward facing protrusions 502d may align with a gap in the contact portions of the contacts 404b, as illustrated in FIGS. 8B and 8C.

A spring clip with an open frame configuration may be formed in any suitable manner, such as by stamping a metal sheet and bending portions of the spring clip into position. For example, a metal sheet may be stamped, and then the spring portions 502a and the stiffener portion 502c may be bent in the downward direction of FIG. 9.

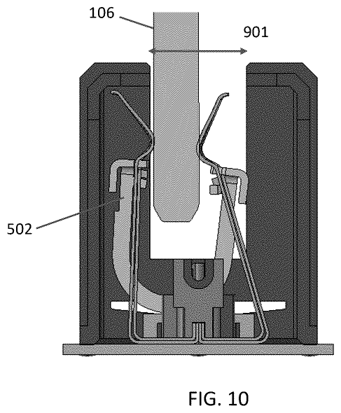

FIG. 10 shows a side view of the connector 500 illustrating how the connector 500 tolerates misalignment of the conductive component 106, which in this example shows the conductive component misaligned by 3 mm to the left in the lateral direction, illustrating connector 500 tolerates misalignment by +/−3 mm. In some embodiments the housing 406 may have an opening width 901 in the lateral direction that is wider than the conductive component 106 with which the connector 500 is configured to made by at least double the misalignment tolerance (e.g., wider by at least 4 mm for a +/−2 mm tolerance and wider by at least 6 mm for a +/−3 mm tolerance. For example, if the width of the conductive component 106 in the lateral direction is 7 mm, the opening width 901 of the housing in the lateral direction may be at least 11 mm, at least 12 mm, or at least 13 mm or more.

Having thus described several aspects of at least one embodiment of this invention, it is to be appreciated that various alterations, modifications, and improvements will readily occur to those skilled in the art. Such alterations, modifications, and improvements are intended to be within the spirit and scope of the invention. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.” Similarly, when a value, such as a dimension is recited without the term “exactly” the value may vary by 5%, 10% or up to 20% in various embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1.-20. (canceled)

21. A connector configured to mechanically and electrically engage with a conductive component, the conductive component being wider along a longitudinal axis than a lateral axis, the connector comprising;
at least one electrical contact configured to mechanically and electrically engage with the conductive component on opposite sides of the conductive component with respect to the lateral axis; and
a spring clip configured to apply a force in an inward direction on the at least one electrical contact to mechanically retain the conductive component, the spring clip comprising:
retaining portions extending along the longitudinal axis, the retaining portions contacting the at least one electrical contact; and
spring portions on opposite sides of the conductive component with respect to the longitudinal axis, the spring portions exerting an inward force on the retaining portions.

22. The connector of claim 21, wherein the spring portions are mechanically connected to one another by the retaining portions.

23. The connector of claim 21, wherein the spring portions are U-shaped.

24. The connector of claim 21, wherein the retaining portions are straight.

25. The connector of claim 21, wherein the at least one electrical contact extends beyond a frame of the spring clip along the lateral axis.

26. The connector of claim 21, wherein the connector is configured to engage with a conductive component that is a busbar.

27. The connector of claim 21, further comprising an adapter plate, wherein the at least one electrical contact is attached to the adapter plate.

28. The connector of claim 27, wherein the adapter plate and the at least one electrical contact have complementary registration features.

29. The connector of claim 28, wherein the adapter plate has registration features configured to allow attachment of the at least one electrical contact to the adapter plate in a first orientation or a second orientation.

30. The connector of claim 29, wherein the first orientation is perpendicular to the second orientation.

31. A spring clip configured to apply a force in an inward direction on at least one electrical contact to mechanically retain a conductive component, the spring clip comprising:
retaining portions extending along a longitudinal axis, the retaining portions contacting the at least one electrical contact; and
spring portions on opposite sides of the conductive component with respect to the longitudinal axis, the spring portions exerting an inward force on the retaining portions.

32. The spring clip of claim 31, wherein the spring portions are mechanically connected to one another by the retaining portions.

33. The spring clip of claim 31, wherein the spring portions are U-shaped.

34. The spring clip of claim 31, wherein the retaining portions are straight.

35. The spring clip of claim 31, wherein the at least one electrical contact extends beyond a frame of the spring clip along a lateral axis perpendicular to the longitudinal axis.

36. The spring clip of claim 31, wherein the conductive component a busbar.

37. A method of assembling a connector, comprising:
attaching at least one electrical contact to a conductive base;
positioning a spring clip over the at least one electrical contact by inserting the at least one electrical contact into an opening at a distal end of the spring clip; and
installing a housing over the at least one electrical contact and the spring clip.

38. The method of claim 37, wherein the conductive base comprises an adapter plate configured to attach the connector to a conductive element.

39. (canceled)

40. The method of claim 37, further comprising aligning registration features of the at least one electrical contact and the conductive base prior to the attaching.

41. The method of claim 37, wherein the attaching of the at least one electrical contact to the conductive base comprises welding the at least one electrical contact to the conductive base.
